(19) United States
(12) Patent Application Publication
(10) Pub. No.: US 2022/0191392 A1
(43) Pub. Date: Jun. 16, 2022

(54) DISPLAY METHOD, DETECTION APPARATUS, AND NON-TRANSITORY COMPUTER-READABLE STORAGE MEDIUM STORING A PROGRAM

(71) Applicant: SEIKO EPSON CORPORATION, Tokyo (JP)

(72) Inventor: Ippei KUROTA, Matsumoto-shi (JP)

(73) Assignee: SEIKO EPSON CORPORATION, Tokyo (JP)

(21) Appl. No.: 17/546,683

(22) Filed: Dec. 9, 2021

(30) Foreign Application Priority Data
Dec. 10, 2020 (JP) 2020-204723

(51) Int. Cl. H04N 5/232; G06T 7/11; G06T 7/70; G06V 10/22

(52) U.S. Cl. CPC H04N 5/23222; G06T 7/11; G06T 7/70; G06T 2207/20021; H04N 5/23293; G06T 2207/30204; G06V 2201/07; G06V 10/225

(57) ABSTRACT

A display method including acquiring a first image by causing a camera to capture an image of a target area in which markers are located, displaying the first image on a display panel, and displaying a second image superimposed on the first image on the display panel, the second image including a guide corresponding to number of the makers located in the target area or the positional relationship among the markers.

The present application is based on, and claims priority from JP Application Serial Number 2020-204723, filed Dec. 10, 2020, the disclosure of which is hereby incorporated by reference herein in its entirety.

### BACKGROUND

### 1. Technical Field

The present disclosure relates to a display method, a detection apparatus, and a program.

### 2. Related Art

In related art, to correct an image projected by a projector, there has been a known approach that causes a camera to capture an image of an image for correction projected by the projector. JP-A-2019-168640 discloses a configuration in which a projector projects an image for correction including marker images for position detection and a detection apparatus captures images of the images for correction.

In the configuration described in JP-A-2019-168640, image processing including binarization and contour extraction is performed on the image captured by the detection apparatus to detect the markers. In the configuration described above, the markers need to be clearly visible in the captured image in order to be accurately detected. It is, however, not easy for a user who performs the imaging to perform imaging suitable for the marker detection.

### SUMMARY

A display method according to an aspect of the present disclosure is a display method executed by a detection apparatus including a display section and an imaging section, the method including acquiring a first image by causing the imaging section to capture an image of a target area in which a plurality of markers are located, displaying the first image on the display section, and displaying a second image including a guide corresponding to the number of makers located in the target area or a positional relationship among the plurality of markers on the display section with the second image superimposed on the first image.

A detection apparatus according to another aspect of the present disclosure includes a display section, an imaging section, an image acquisition section that acquires a first image by causing the imaging section to capture an image of a target area in which a plurality of markers are located, and a control section that superimposes the first image on a second image including a guide corresponding to the number of makers located in the target area or a positional relationship among the plurality of markers and causes the display section to display a resultant image.

A non-transitory computer-readable storage medium according to another aspect of the present disclosure stores a program executed by a computer that controls a detection apparatus including a display section and an imaging section, the program causing the computer to function as an image acquisition section that acquires a first image by causing the imaging section to capture an image of a target area in which a plurality of markers are located, and a control section that superimposes the first image on a second image including a guide corresponding to the number of makers located in the target area or a positional relationship among the plurality of markers and causes the display section to display a resultant image.

### BRIEF DESCRIPTION OF THE DRAWINGS

FIG. 1 shows an example of the configurations of an image display system in a first embodiment.

FIG. 2 shows an example of a displayed guide image.

FIG. 3 shows another example of the displayed guide image.

FIG. 4 is a flowchart showing the action of the image display system in the first embodiment.

FIG. 5 is a sequence diagram showing the action of the image display system in the first embodiment.

FIG. 6 shows an example of the configuration of the image display system according to a second embodiment.

FIG. 7 is a sequence diagram showing the action of the image display system in the second embodiment.

FIG. 8 shows an example of the configuration of the image display system according to a third embodiment.

FIG. 9 is a flowchart showing the action of the image display system in the third embodiment.

FIG. 10 shows an example of the configuration of the image display system according to a fourth embodiment.

FIG. 11 is a flowchart showing the action of the image display system in the fourth embodiment.

### DESCRIPTION OF EXEMPLARY EMBODIMENTS

Embodiments of the present disclosure will be described below with reference to the drawings. A variety of technically preferable restrictions are imposed on the embodiments described below. The embodiments of the present disclosure are, however, not limited to the forms described below.

### 1. First Embodiment

### 1-1. Configuration of Projection System

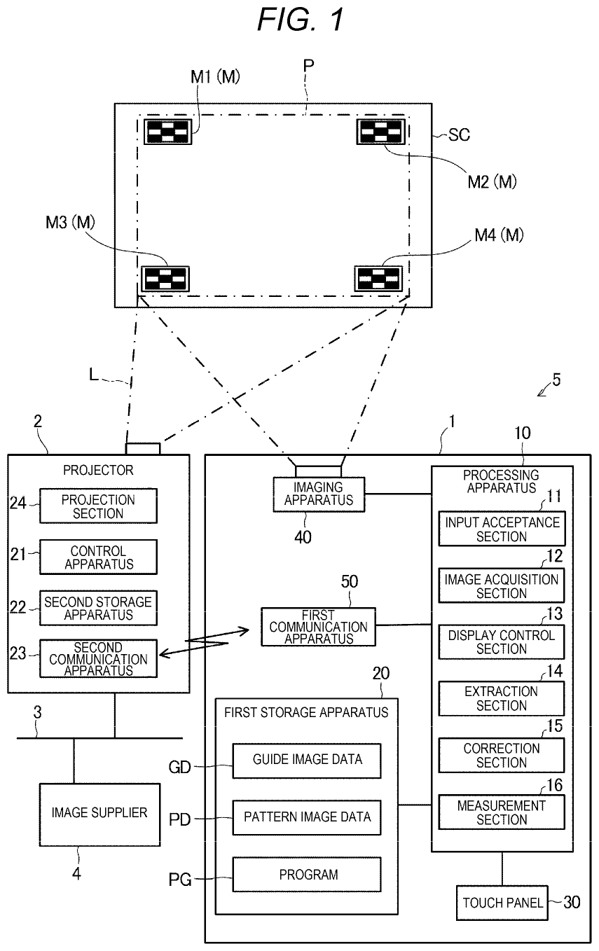

FIG. 1 is a block diagram showing an example of the configurations of an image display system 5 according to a first embodiment of the present disclosure.

The image display system 5 includes a detection apparatus 1, a projector 2, and an image supplier 4.

The projector 2 and the image supplier 4 are coupled to a network 3. Specific examples of the network 3 may include a wired LAN (local area network), a wireless LAN, and Bluetooth. Bluetooth is a registered trademark. The projector 2 and the image supplier 4 are coupled to each other via the network 3 so as to be communicable with each other. The image supplier 4 supplies the projector 2 with image data.

The projector 2 projects image light L onto a projection receiving object SC based on the image data supplied from the image supplier 4 or the detection apparatus 1 and forms a projection image P on the projection receiving object SC. The projector 2 is an example of a display apparatus, and the state in which the projector 2 projects the image light L corresponds to the state in which the projector 2 performs display operation.

The projection receiving object SC is an object which is present in a position facing the projector 2 and onto which the image light L is projected. The projection receiving object SC is not limited to a specific object and may be any object that is present in a position where the image light L is projected on the object and allows the projection image P to be formed thereon. The projection receiving object SC may be a screen formed of a flat plate or a curtain or may be a wall surface of a building. A surface of the projection receiving object SC that is the surface on which the image light L is projected is not limited to a flat surface and may instead be a curved surface or a surface with irregularities. The surface of the projection receiving object SC on which the image light L is projected may include a plurality of surfaces that are not contiguous with each other. The surface of the projection receiving object SC is an example of the target area in the present disclosure.

The detection apparatus 1 has the function of capturing an image of the projection receiving object SC and displaying the captured image. The aspect of the detection apparatus 1 is not limited to any specific aspect. The detection apparatus 1 may, for example, be a smartphone, a tablet computer, or a laptop computer. The detection apparatus 1 may be a digital camera.

### 1-2. Configuration of Detection Apparatus

The detection apparatus 1 includes a processing apparatus 10, a first storage apparatus 20, a touch panel 30, an imaging apparatus 40, and a first communication apparatus 50.

The processing apparatus 10 is formed of a processor, for example, a CPU (central processing unit). The processing apparatus 10 maybe formed of a single processor or a plurality of processors.

The processing apparatus 10 reads a program PG from the first storage apparatus 20 and executes the program PG to control each portion of the detection apparatus 1. The processing apparatus 10 executes the program PG to work as an input acceptance section 11, an image acquisition section 12, a display control section 13, an extraction section 14, a correction section 15, and a measurement section 16 in the form of cooperation between software and hardware.

The first storage apparatus 20 stores programs and data so as to be readable by the processing apparatus 10. The first storage apparatus 20 includes a nonvolatile memory that stores the programs and data in a nonvolatile manner. The nonvolatile memory of the first storage apparatus 20 is formed, for example, of a ROM (read only memory), an EPROM (erasable programmable read only memory), an EEPROM (electrically erasable programmable read only memory), or a flash memory. The first storage apparatus 20 may further include a volatile memory that temporarily stores the programs and data. The volatile memory is, for example, a RAM (random access memory).

The first storage apparatus 20 stores the program PG executed by the processing apparatus 10. The volatile memory of the first storage apparatus 20 is used by the processing apparatus 10 as a work area where the processing apparatus 10 executes the program PG. The program PG is also referred to as an application program, application software, or an app.

In the first embodiment, the first storage apparatus 20 stores a plurality of guide image data GD and a plurality of pattern image data PD. These data will be described later in detail.

The detection apparatus 1 may acquire the program PG, the guide image data GD, and the pattern image data PD, for example, from a server that is not shown via the first communication apparatus 50 and store the acquired program and data in the first storage apparatus 20. The detection apparatus 1 may store the program PG, the guide image data GD, and the pattern image data PD in advance in the first storage apparatus 20.

The touch panel 30 includes a display panel that is not shown but displays a variety of images and letters under the control of the processing apparatus 10. The display panel of the touch panel 30 includes a touch sensor that is not shown but detects touch operation performed, for example, with a user's finger. The touch sensor is formed, for example, of a capacitive sensor or a pressure sensitive sensor. The touch sensor is disposed so as to be superimposed on the display panel. The touch panel 30 functions as an input section that detects input provided by touch operation and as a display section that displays information on the display panel.

The imaging apparatus 40 is a digital camera including an optical system formed of a lens group and other optical components, and an imaging device. The imaging apparatus 40 performs imaging under the control of the processing apparatus 10 and outputs data on a captured image generated based on a signal read from the imaging device to the processing apparatus 10. The imaging apparatus 40 corresponds to an example of an imaging section.

The first communication apparatus 50 is a wireless communication module that performs wireless data communication based, for example, on a wireless LAN or Bluetooth or a wired communication module that performs wired data communication via a cable. The wireless communication module includes, for example, an antenna, an RF circuit, and a baseband circuit. The wired communication module includes a connector to which the cable is coupled and an interface circuit that processes signals transmitted and received via the connector.

The first communication apparatus 50 communicates with the projector 2 under the control of the processing apparatus 10.

The input acceptance section 11 provided in the processing apparatus 10 detects operation performed on the touch panel 30 to accept input from the user.

The image acquisition section 12 acquires captured images from the imaging apparatus 40. The image acquisition section 12 acquires images captured by the imaging apparatus 40 at predetermined time intervals when the imaging apparatus 40 is in operation. The image acquisition section 12 acquires captured images from the imaging apparatus 40 at the predetermined time intervals even when the user is not performing what is called shutter operation, which is imaging instructing operation issued by the user. The captured images are referred to as camera images below. The camera images correspond to an example of a first image.

The image acquisition section 12 acquires captured images from the imaging apparatus 40 when accepting the shutter operation via the input acceptance section 11. The captured images acquired by the image acquisition section 12 triggered by the shutter operation are referred to as shutter images below.

The display control section 13 displays an image on the display panel of the touch panel 30 under the control of the processing apparatus 10. The display control section 13 transmits image data to the projector 2 via the first communication section 50. The display control section 13 corresponds to an example of a control section.

The imaging apparatus 40 captures images of the projection receiving object SC on which markers M are located, and the extraction section 14 extracts the markers M from the captured images.

The correction section 15 and the measurement section 16 carry out a correction process and a measurement process, respectively, based on the captured images, captured by the imaging apparatus 40, of the projection receiving object SC on which the markers M are located.

The functions of the extraction section 14, the correction section 15, and the measurement section 16 will be described later in detail.

### 1-3. Configuration of Projector

The projector 2 includes a control apparatus 21, a second storage apparatus 22, a second communication apparatus 23, and a projection section 24. The control apparatus 21 includes a processor, such as a CPU, and executes a program. The control apparatus 21 controls each portion of the projector 2 by executing a basic control program that is not shown but is stored in the second storage apparatus 22.

The second storage apparatus 22 includes a nonvolatile memory formed of a ROM, an EPROM, an EEPROM, a flash memory, or any other memory and stores programs and data in the nonvolatile memory. The second storage apparatus 22 may further include a volatile memory, such as a RAM, and may temporarily store the programs and data.

The second communication apparatus 23 is a wireless communication module that performs wireless data communication based, for example, on wireless LAN or Bluetooth or a wired communication module that performs wired data communication via a cable. The wireless communication module includes, for example, an antenna, an RF circuit, and a baseband circuit. The wired communication module includes a connector to which the cable is coupled and an interface circuit that processes signals transmitted and received via the connector. The second communication apparatus 23 performs communication with the first communication apparatus 50 provided in the detection apparatus 1.

The projection section 24 includes a light source, an optical modulator that modulates the light outputted by the light source to generate the image light L, and an optical system that projects the image light L. The light source is, for example, a lamp or a solid-state light source. The solid-state light source is, for example, an LED (light emitting diode) or a laser light source. The light modulator has a configuration in which a transmissive liquid crystal panel is used to modulate light, a configuration in which a reflective liquid crystal panel is used to modulate light, or a configuration in which a digital mirror device is used to modulate light. The projection section 24 projects the image light L onto the projection receiving object SC under the control of the control apparatus 21. That is, the control apparatus 21 displays the projection image P by controlling the projection section 24.

The control apparatus 21 causes the projection section 24 to display the projection image P based on image data stored in the second storage apparatus 22. The control apparatus 21 causes the second storage apparatus 22 to store image data received from the detection apparatus 1 via the second communication apparatus 23 and displays the projection image P based on the image data.

### 1-4. Process Relating to Markers

A plurality of markers M are located on the projection receiving object SC, as shown in FIG. 1. FIG. 1 shows a case where four markers M1, M2, M3, and M4 are located on the projection receiving object SC. When the markers M1, M2, M3, and M4 are not distinguished from one another, the markers M1, M2, M3, and M4 are collectively referred to as the markers M.

The state in which the markers M are located means that the markers M appear on the surface of the projection receiving object SC with an image of the markers M being allowed to be captured by the detection apparatus 1. The configuration of each of the markers M is not limited to a specific configuration. The markers M may instead be contained in the projection image P. The markers M may each be an object stuck or otherwise placed on the surface of the projection receiving object SC. The markers M may still instead be drawn on the surface of the projection receiving object SC. The markers M may still instead each be a projection image projected by a projection apparatus different from the projector 2 onto the projection receiving object SC. The state in which the markers M are located includes all the states described above.

In the first embodiment and in a second embodiment described later, the markers M are contained in the projection image P from the projector 2. In third and fourth embodiments described later, the markers M are each an object placed on the projection receiving object SC.

The image display system 5 causes the detection apparatus 1 to capture an image of the target area where the plurality of markers M are located, causes the detection apparatus 1 to detect the markers M in the captured image, and causes the detection apparatus 1 to identify the coordinates of the markers M in the captured image. The detection apparatus 1 then detects the three-dimensional shape of the projection receiving object SC based on the coordinates of the markers M. Based on the result of the detection performed by the detection apparatus 1, the image display system 5 deforms the projection image from the projector 2 in such a way that the deformed projection image corresponds to the shape of the projection receiving object SC. The projection image P can thus be projected so as to stick to the projection receiving object SC.

The user operates the detection apparatus 1 to cause the imaging apparatus 40 to capture an image in such a way that the imaging range, that is, the angle of view of the imaging apparatus 40 contains the plurality of markers M. The image captured by the imaging apparatus 40 contains images of the plurality of markers M.

In the present embodiment, the projector 2 sequentially projects a plurality of measurement patterns. The detection apparatus 1 captures images of the measurement patterns projected by the projector 2 onto the projection receiving object SC.

The measurement patterns are each a structured pattern generated by using a spatial coding method or a phase shifting method. In the present embodiment, a binary code pattern is presented as an example of the measurement patterns. The binary code pattern refers to an image for expressing coordinates by using a binary code. The binary code is a technique for expressing the value at each digit of a binary number that expresses an arbitrary numeral by using on and off states of a switch. When a binary code pattern is used as each of the measurement patterns, an image projected by the projector 2 corresponds to the switches described above, and it is necessary to prepare images the number of which is equal to the number of digits of the binary number representing coordinates.

The coordinates are formed, for example, of a coordinate X along an axis X horizontally extending in a captured image and a coordinate Y along an axis Y perpendicular to the axis X in the captured image. The measurement patterns each require separate images for the coordinates X and Y. For example, when the projector 2 has a resolution of 120×90 pixels, the numerals 120 and 90 are each expressed by a seven-digit binary number, so that seven images are required to express the coordinate X, and another seven images are required to express the coordinate Y.

When a binary code pattern is used, a complimentary pattern can be used in combination of the binary code pattern to suppress an effect of ambient light so as to improve the robustness of the measurement. The complementary pattern refers to a reversal image of the binary code pattern in terms of black and white. For example, a binary code pattern in which white represents 1 and black represents 0 is referred to as a positive pattern, and the complementary pattern, which is the reversal of the binary code pattern in terms of black and white, is referred to as a negative pattern. As an example of the measurement patterns, when the resolution indicated by resolution information is 120×90 pixels, 28 measurement patterns including 14 positive patterns and 14 negative patterns are projected by the projector 2.

The markers M contained in each of the measurement patterns may each be a dot pattern, a rectangular pattern, a polygonal pattern, a checker pattern, a gray code pattern, a phase shift pattern, or a random dot pattern.

The markers M are located for alignment of each of the measurement patterns. For example, the markers M, which are each the source of extraction of a feature point for the alignment, are located at the four corners of each of the measurement patterns, as shown in FIG. 1. In the present embodiment, a case where the detection apparatus 1 extracts one feature point from one marker M is presented. The detection apparatus 1 may extract a plurality of feature points from one marker. In the present embodiment, four markers M are located in one measurement pattern, and the number of markers M located in one measurement pattern only needs to be two or more and may therefore be three, five, or more. When at least two markers M are located in each of the measurement patterns, an image projected on the projection receiving object SC can be enlarged, reduced, and translated. When three markers M are located in each of the measurement patterns, affine transformation can be performed, and when four or more markers M are located in each of the measurement patterns, projective transformation can be performed, whereby the measurement patterns can be aligned with each other.

In the present embodiment, quadrangular markers M are used as shown in FIG. 1, and the markers M may have an arbitrary shape, such as a circle or triangle shape. In the present embodiment, the markers M are located at the four corners of each of the measurement patterns and may instead be located outside the measurement patterns. As for portions of each of the measurement pattern that are the portions where the markers M are located, the measurement pattern cannot be read, so that projection positions where the markers M are projected cannot be measured. It is therefore preferable that the markers M are located in the vicinity of the outer circumference of each of the measurement patterns or outside each of the measurement patterns so as not to affect the measurement. As a more preferable example, the case where the markers M are located at the four corners of each of the measurement patterns is presented in the present embodiment. When the four markers M are located on the projection receiving object SC, the user of the detection apparatus 1 adjusts the position and orientation of the detection apparatus 1 in such a way that an image containing all the four markers M is captured.

The detection apparatus 1 causes the image acquisition section 12 to acquire images captured by the imaging apparatus 40. The image acquisition section 12 acquires an image of each of the plurality of measurement patterns captured by the imaging apparatus 40 when the plurality of measurement patterns are located on the projection receiving object SC. The extraction section 14, the correction section 15, and the measurement section 16 carry out respective processes by using the plurality of captured images acquired by the image acquisition section 12.

The extraction section 14 carries out an extraction process. In the extraction process, the extraction section 14 uses one of the plurality of captured images as a reference image and extracts reference feature points, which serve as the reference for alignment between the reference image and the other captured images, from the markers in the reference image. The extraction section 14 sets each of the plurality of captured images excluding the reference image as a processing target image. The extraction section 14 extracts feature points corresponding to the reference feature points from the images of the markers M contained in the processing target images. In the present embodiment, four markers are contained in one measurement pattern. The extraction section 14 extracts one feature point from one marker and therefore extracts four feature points from one captured image.

There are a variety of conceivable aspects of how to select the reference image from a plurality of captured images. For example, it is conceivable to select a reference image based on the imaging order. Specifically, out of the plurality of captured images, the image captured first or last is used as the reference image.

The extraction section 14 may instead extract feature points at the four corners of each of the captured images, calculate a statistic of the positions of the feature points, such as the average or median, and use an image having feature points in the positions closest to the calculated statistic as the reference image. The extraction section 14 may still instead present the plurality of captured images to the user and allow the user to select a reference image.

The correction section 15 carries out a correction process. In the correction process, the correction section 15 deforms each of the processing target images in such a way that the positions of the four feature points extracted from the processing target image coincide with the positions of the four reference feature points extracted from the reference image. In the correction process, the correction section 15 deforms each of the plurality of processing target images. The state in which the positions of the feature points coincide with the positions of the reference feature points means that the former coordinates fully coincide with the latter coordinate or that the difference between the former coordinates and the latter coordinates falls within a prespecified error range. Specific examples of how to deform a processing target image may include enlargement, reduction, translation, and affine transformation.

For example, when the image capture apparatus 40 captures images of three captured images as the captured images of the projection receiving object SC, the extraction section 14 extracts first feature points, which correspond to the reference feature points extracted from the reference image, from a first captured image, which is one of the two processing target images. The extraction section 14 further extracts second feature points, which correspond to the reference feature points, from the other of the two processing target images, that is, a second captured image different from the first captured image. The correction section 15 then deforms the first captured image in such a way that the positions of the reference feature points coincide with the positions of the first feature points and deforms the second captured image in such a way that the positions of the reference feature points coincide with the positions of the second feature points.

The measurement section 16 performs a measurement process. In the measurement process, the measurement section 16 measures the projection positions from at least two of the plurality of processing target images deformed by the correction section 15 and the reference image. When a binary code pattern is used as each of the measurement patterns, as in the present embodiment, the measurement section 16 may measure the projection positions by using all the processing target images deformed by the correction section 15 and the reference image. When the reference image is a captured image of a positive pattern, the measurement section 16 may measure the projection positions by using only the processing target image of the positive pattern. Similarly, when the reference image is a captured image of a negative pattern, the measurement section 16 may measure the projection positions by using only the processing target image of the negative pattern.

In the present embodiment, to cause the projector 2 to display the measurement patterns, the detection apparatus 1 stores the pattern image data PD in the first storage apparatus 20. The display control section 13 of the detection apparatus 1 transmits the pattern image data PD to the projector 2. The projector 2 projects the image light L based on the pattern image data PD to cause the projection image P of each of the measurement patterns to appear on the projection receiving object SC. The projection image P of each of the measurement patterns each containing the plurality of markers M corresponds to an example of a third image.

The pattern image data PD is preferably data corresponding to the resolution of a displayed image displayed by the projection section 24 of the projector 2. To this end, the display control section 13 may communicate with the projector 2 via the first communication apparatus 50 and receives resolution information representing the resolution of images projected by the projection section 24. In this case, the display control section 13 selects pattern image data PD corresponding to the resolution information received from the projector 2 from the plurality of pattern image data PD stored in the first storage apparatus 20 and transmits the selected pattern image data PD to the projector 2.

To assist the user in performing the operation of capturing an image of the markers M located on the projection receiving object SC, the detection apparatus 1 causes the touch panel 30 to display a guide image in the image capturing operation. This process is carried out by the display control section 13.

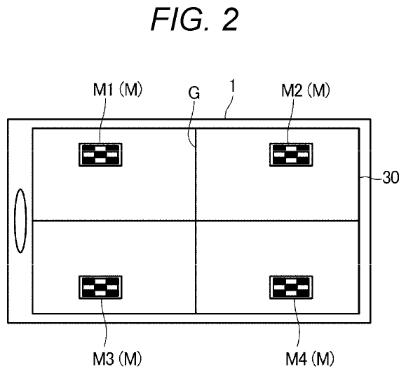

FIG. 2 shows an example of the displayed guide image.

The touch panel 30 is disposed in the main body of the detection apparatus 1, as shown in FIG. 2. The detection apparatus 1 acquires camera images from the imaging apparatus 40 when the imaging apparatus 40 of the detection apparatus 1 is in operation and displays the camera images on the touch panel 30. In the example shown in FIG. 2, a camera image containing the four markers M1, M2, M3, and M4 is displayed on the touch panel 30.

The display control section 13 causes the touch panel 30 to display the entire camera image acquired by the image acquisition section 12. To cause the correction section 15 to carry out the correction process and the measurement section 16 to carry out the measurement process, it is desirable that the detection apparatus 1 captures an image of the plurality of markers M contained in each of the measurement patterns.

The display control section 13 displays a guide image G on the touch panel 30 with the guide image G superimposed on the camera image from the imaging apparatus 40. The guide image G is an image showing the positions where the markers M should be located in a camera image. The guide image G is an image corresponding to at least one of the number of markers M located on the projection receiving object SC and the positional relationship among the plurality of markers M. The guide image G corresponds to an example of a second image.

In the present embodiment, the four markers M are located on the projection receiving object SC. The four markers M are arranged in the horizontal and vertical directions with two markers M along each of the directions. In detail, the markers M1 and M2 are arranged horizontally, and the markers M3 and M4 are arranged horizontally. The markers M1 and M3 are arranged vertically, and the markers M2 and M4 are arranged vertically. The four markers M1, M2, M3, and M4 are arranged to form the vertices of a rectangle. The guide image G corresponds to the positional relationship among the four markers M1, M2, M3, and M4.

The guide image G shown in FIG. 2 is an image that segments a camera image from the detection apparatus 1 into four areas. In the present embodiment, a case where the guide image G is formed of line segments is presented. One of the areas segmented by the guide image G corresponds to an example of a first image area, and another one of the areas segmented by the guide image G corresponds to an example of a second image area. The first image area is associated with any of the plurality of markers M located on the projection receiving object SC. The second image area is associated with any of the markers M that differs from the marker M associated with the first image area. The guide image G, which is formed of the line segments that segment a camera image into four areas, corresponds to an example of an image indicating the boundary between a plurality of image areas.

The display control section 13 displays the guide image G based on the guide image data GD stored in the first storage apparatus 20. The guide image data GD is data for displaying the guide image G corresponding to the resolution and shape of a camera image acquired by the image acquisition section 12. The guide image data GD may be image data on the guide image G or may be data containing, for example, a parameter, a computation formula, or a program for generating the guide image G, for example, based on computation.

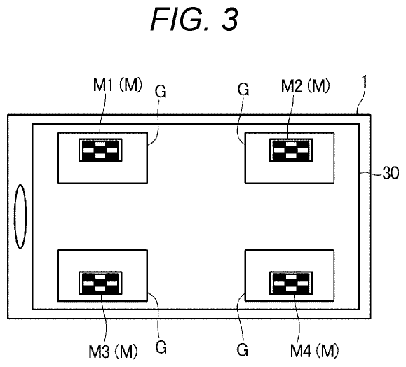

FIG. 3 shows another example of the displayed guide image G.

The guide image G shown in FIG. 3 contains a plurality of rectangles. The guide image G contains the rectangles the number of which is the same as the number of markers M located on the projection receiving object SC. The positional relationship among the plurality of rectangles contained in the guide image G corresponds to the positional relationship among the plurality of markers M located on the projection receiving object SC. The guide image G containing a plurality of rectangles corresponds to an example of an image indicating the boundary between a plurality of image areas.

The guide image G formed of the line segments can be called a first aspect of the guide image G, and the guide image G formed of the rectangles can be called a second aspect of the guide image G. The detection apparatus 1 executes one of a first mode in which the guide image G in the first aspect is displayed and a second mode in which the guide image G in the second aspect is displayed. The detection apparatus 1 may be configured to be capable of switching the execution mode between the first mode and the second mode. In this case, the detection apparatus 1 stores in the first storage apparatus 20 the guide image data GD for displaying the guide image G in the first aspect and the guide image data GD for displaying the guide image Gin the second aspect. The detection apparatus 1 may instead display a guide image G in an aspect different from the first and second aspects. For example, the detection apparatus 1 may display a guide image G in a third aspect in which the areas where the markers M should be positioned are each a circle.

The guide image G allows the user to capture an image in such a way that one marker M is contained in each of the areas segmented by the guide image G. By adjusting the position and orientation of the detection apparatus 1 in accordance with the guide image G, the user can produce an image in which the four markers M are positioned at the four corners of the image. That is, the user captures an image in such a way that the markers M fall within the areas segmented by the guide image G. The extraction section 14 detects the markers M from an image captured by the imaging apparatus 40 on the assumption that the areas segmented by the guide image G each contain one marker M. Specifically, the extraction section 14 extracts one of the areas segmented by the guide image G from the captured image and detects the position of the marker M based on the values of the pixels contained in the extracted area. By carrying out the aforementioned process for the plurality of areas segmented by the guide image G, the extraction section 14 detects one marker M from the first image area and one marker M from the second image area. Compared to the process of detecting a plurality of markers M from an entire captured image, the aforementioned process is a light-load process because the number of pixels to be processed is smaller. The extraction section 14 can therefore detect the markers M at high speed and with high accuracy.

The positional relationship among the markers M refers to the relative positional relationship between any two or more of the plurality of markers M located on the projection receiving object SC. When the projection receiving object SC has an unknown shape, the positional relationship among the markers M cannot be accurately identified, so that the positional relationship among the markers M may instead be a positional relationship estimated with the projection image P projected onto the projection receiving object SC.

Still instead, the positional relationship among the markers M is the positional relationship among the plurality of markers M in an image formed by the projection section 24 based on the pattern image data PD. The light modulator of the projection section 24 forms an image containing the plurality of markers M based on the pattern image data PD and generates the image light L by using the formed image. In this case, the positional relationship among the markers M refers to the relative positional relationship between any two or more of the plurality of markers M contained in an image formed by the projection section 24 based on the pattern image data PD. When the pattern image data PD is image data itself on the measurement patterns, the positional relationship among the markers M may be the positional relationship among the markers M in the pattern image data PD.

### 1-5. Action of Projection System

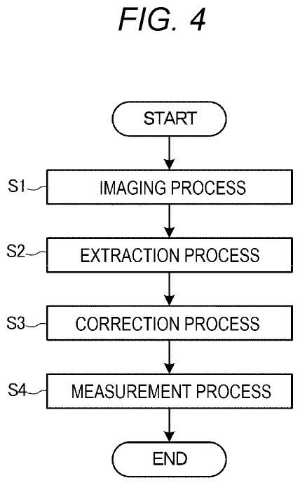

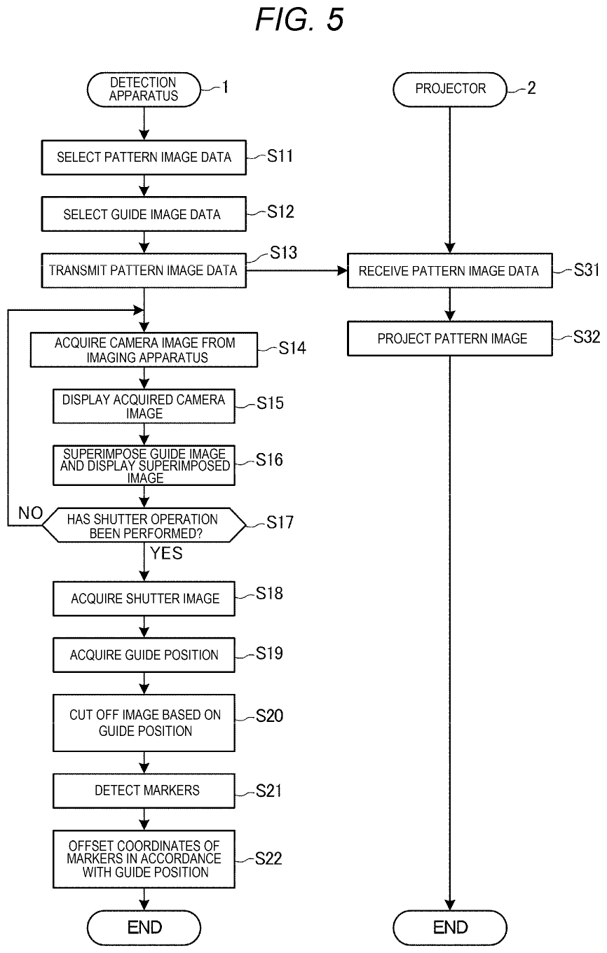

FIG. 4 is a flowchart showing the action of the image display system 5. In the actions shown in FIG. 4 and FIG. 5, the latter of which will be described below, the detection apparatus 1 operates in accordance with the program PG.

The image display system 5 causes the detection apparatus 1 and the projector 2 to carryout an imaging process (step S1). In the imaging process, the projector 2 displays the projection image P of each of the measurement patterns each containing the markers M, and the detection apparatus 1 captures images of the projection receiving object SC.

The detection apparatus 1 carries out the extraction process (step S2). In the extraction process, the processing apparatus 10 functions as the extraction section 14. The extraction section 14 extracts the reference feature points from the reference image selected from a plurality of shutter images captured by the imaging apparatus 40 and extracts feature points corresponding to the reference feature points from each of the processing target images, which are shutter images excluding the reference image.

The detection apparatus 1 carries out the correction process (step S3). In the correction process, the processing apparatus 10 functions as the correction section 15. The correction section 15 deforms each of the processing target images in such a way that the positions of the feature points extracted from the processing target image coincide with the positions of the reference feature points.

The detection apparatus 1 carries out the measurement process (step S4). In the measurement process, the processing apparatus 10 functions as the measurement section 16. The measurement section 16 measures the projection positions from at least two of the processing target images deformed in the correction process and the reference image.

FIG. 5 is a sequence diagram showing the action of the image display system 5. In detail, FIG. 5 shows the action of the detection apparatus 1 and the projector 2 in the imaging and extraction processes in FIG. 4.

The detection apparatus 1 selects pattern image data PD to be displayed by the projector 2 from the plurality of pattern image data PD stored in the first storage apparatus (step S11). In step S11, the processing apparatus 10 functions as the display control section 13. The display control section 13 selects pattern image data PD corresponding to the resolution of images projected by the projector 2 from the plurality of pattern image data PD. In step S11, the display control section 13 may select pattern image data PD corresponding to a specified condition. For example, the display control section 13 may select pattern image data PD for displaying a measurement pattern containing the markers M the number of which is specified by input operation performed on the touch panel 30.

The display control section 13 selects guide image data GD corresponding to the pattern image data PD selected in step S11 from the plurality of guide image data GD stored in the first storage device 20 (step S12). In detail, the display control section 13 selects a guide image G that corresponds to the number of markers M contained in the pattern image data PD selected in step S11 and the positional relationship among the markers M displayed on the projection receiving object SC based on the pattern image data PD.

The display control section 13 transmits the pattern image data PD selected in step S11 to the projector 2 via the first communication apparatus 50 (step S13).

The projector 2 receives the pattern image data PD transmitted by the detection apparatus 1 via the second communication apparatus 23 (step S31). The control apparatus 21 of the projector 2 controls the projection section 24 based on the received pattern image data PD and projects the image light L corresponding to the projection image P onto the projection receiving object SC (step S32).

The processing apparatus 10 functions as the image acquisition section 12, turns on the imaging apparatus 40, and acquires camera images from the imaging apparatus 40 (step S14). The camera images acquired by the image acquisition section 12 are captured images outputted by the imaging apparatus 40 when the imaging apparatus 40 is in operation but the user is not operating the shutter.

The display control section 13 displays the camera image acquired by the image acquisition section 12 on the touch panel 30 (step S15). The display control section 13 superimposes the guide image G based on the guide image data GD selected in step S12 onto each of the camera images and displays the resultant image on the touch panel 30 (step S16).

The processing apparatus 10 evaluates whether or not the user has operated the shutter (step S17). The shutter operation is operation performed by the user through a touching action on the touch panel 30 or operation performed on a button that is not shown but is provided on the detection apparatus 1.

When no shutter operation has been performed (NO in step S17), the processing apparatus 10 returns to step S14.

When the shutter operation is performed (YES in step S17), the processing apparatus 10 acquires a shutter image from the imaging apparatus 40 by using the function of the image acquisition section 12 (step S18). The shutter image is a captured image generated by the imaging apparatus 40 at the timing when the shutter operation is performed. The shutter image may be an image captured under the same imaging conditions as those under which the camera images are captured and therefore have the same resolution as that of the camera images. Instead, when the shutter operation is performed, the imaging apparatus 40 may capture an image under imaging conditions different from the imaging conditions under which the camera images are outputted. The shutter image may have resolution different from the resolution of the camera images. The imaging conditions used herein refer to the exposure, white balance, presence or absence of an image stabilization function, whether color imaging or black-and-white imaging is performed, and other factors.

The extraction section 14 acquires the position of the guide image G in the shutter image acquired in step S18 (step S19). In step S19, the extraction section 14 acquires the position of the guide image G in the shutter image, for example, by identifying the position of the guide image G based on the guide image data GD selected in step S12. The position of the guide image G is, for example, the coordinates of the guide image G in the shutter image. In detail, the position of the guide image G is the coordinates of a vertex of a line segment, a rectangle, or any other figure that forms the guide image G or one of areas segmented by the guide image G.

The extraction section 14 cuts off part of the shutter image based on the position of the guide image G acquired in step S19 (step S20). In step S20, the extraction section 14 cuts off a plurality of areas including the first image area corresponding to one marker M and the second image area corresponding to another marker M.

The extraction section 14 detects images of the markers M in the images of the areas cut off the shutter image (step S21). The extraction section 14 acquires the pixel values of the pixels contained in the first image area. The extraction section 14 identifies the pixels that form the image of each of the markers M, for example, by comparing the average of the pixel values in the first image area with the pixel value of each of the pixels therein or by comparing the pixel values of adjacent pixels therein. The extraction section 14 extracts feature points from each of the images of the markers M and determines the coordinates of each of the feature points.

Furthermore, the extraction section 14 offsets the coordinates of each of the determined feature points by the amount corresponding to the coordinates in the guide image G that correspond to the area where the feature point is extracted (step S22). The offsetting refers to the process of translating the coordinates of a feature point by the coordinates in the guide image G. The extraction section 14 carries out the processes in steps S21 to S22 for all areas cut off in accordance with the guide image G on an area basis.

### 1-6. Effects of First Embodiment

The display method according to the present disclosure is a display method executed by the detection apparatus 1 including the touch panel 30 and the imaging apparatus 40. The display method according to the present disclosure includes acquiring a camera image by causing the imaging apparatus 40 to capture an image of the projection receiving object SC on which a plurality of markers M are located, displaying the camera image on the touch panel 30, and displaying the guide image G including a guide corresponding to the number of makers M located on the projection receiving object SC or the positional relationship among the plurality of markers M on the touch panel 30 with the guide image G superimposed on the camera image.

The detection apparatus 1 according to the present disclosure includes the touch panel 30, the imaging apparatus 40, the image acquisition section 12, which acquires a camera image by causing the imaging apparatus 40 to capture an image of the projection receiving object SC on which a plurality of markers M are located, the display control section 13, which superimposes the camera image on the guide image G including a guide corresponding to the number of makers M located on the projection receiving object SC or the positional relationship among the plurality of markers M and causes the touch panel 30 to display the resultant image.

The program PG according to the present disclosure is a program executed by the processing apparatus 10, which is a computer that controls the detection apparatus 1 including the touch panel 30 and the imaging apparatus 40. The program PG causes the processing apparatus 10 to function as the image acquisition section 12, which causes the imaging apparatus 40 to acquire a camera image of the projection receiving object SC on which a plurality of markers M are located, and the display control section 13, which superimposes the camera image on the guide image G including a guide corresponding to the number of makers M located on the projection receiving object SC or the positional relationship among the plurality of markers M and causes the touch panel 30 to display the resultant image.

The user who operates the detection apparatus 1 can thus use the guide image G as a guide to capture an image of the markers M located on the projection receiving object SC. The user can thus readily capture an image suitable for measurement of the projection receiving object SC.

The display method according to the present disclosure causes the projector 2 to display the projection image P containing the plurality of markers M in the target area. The function of the projector 2 thus allows the plurality of markers M to be quickly located on the projection receiving object SC.

The display method described in the first embodiment includes transmitting the pattern image data PD, which the detection apparatus 1 stores in advance, from the detection apparatus 1 to the projector 2. The projector 2 displays the projection image P based on the pattern image data PD transmitted from the detection apparatus 1. The detection apparatus 1 displays the guide image G based on the guide image data GD, which the detection apparatus 1 stores in advance.

The projector 2 can thus display the measurement patterns each including the markers M by simply performing the function of projecting the projection image P based on the data received from the detection apparatus 1. The display method according to the present disclosure can therefore be achieved without implementing a specific function of displaying the measurement patterns into the projector 2.

The display method according to the present disclosure executes one of the first mode, in which the guide image G in the first aspect is displayed with the guide image G superimposed on the camera image, and the second mode, in which the guide image G in the second aspect different from the first aspect is displayed with the guide image G superimposed on the camera image.

A guide image G in an aspect suitable for the measurement of the projection receiving object SC can thus be displayed. The convenience of the user who uses the detection apparatus 1 to capture an image of the markers M can thus be further enhanced.

In the display method according to the present disclosure, the plurality of markers M located on the projection receiving object SC include a first marker and a second marker. The camera image contains a plurality of image areas, and the plurality of image areas include a first image area and a second image area. The guide image G is an image showing the boundary between the plurality of image areas. For example, the guide image G is a line segment. The first image area is associated with the first marker located on the projection receiving object SC, and the second image area is associated with the second marker located on the projection receiving object SC. The user can thus capture an image suitable for the detection of the markers M from a shutter image.

In the display method described in the first embodiment, the guide image G is line segments that divide a camera image into a plurality of image areas. The user can thus more readily perform the operation of adjusting the position and orientation of the detection apparatus 1 in such a way that the positions of the markers M fit into the guide image G.

The display method according to the present disclosure includes causing the detection apparatus 1 to detect the position of the first marker based on the values of the pixels contained in the first image area out of the pixels that form a camera image and detect the position of the second marker based on the values of the pixels contained in the second image area out of the pixels that form the camera image. The load of the process of detecting images of markers M from a shutter image can thus be reduced, whereby the markers M can be detected at higher speed and with higher accuracy.

The first embodiment has been described with reference to the configuration in which the detection apparatus 1 stores the pattern image data PD, but the apparatus that stores the pattern image data PD is not limited to the detection apparatus 1. For example, the projector 2 may store the pattern image data PD in the second storage apparatus 22. In this case, the display control section 13 may in step S13 transmit data that specifies the pattern image data PD to the projector 2, and the control apparatus 21 may read the specified pattern image data PD from the second storage apparatus 22.

### 2. Second Embodiment

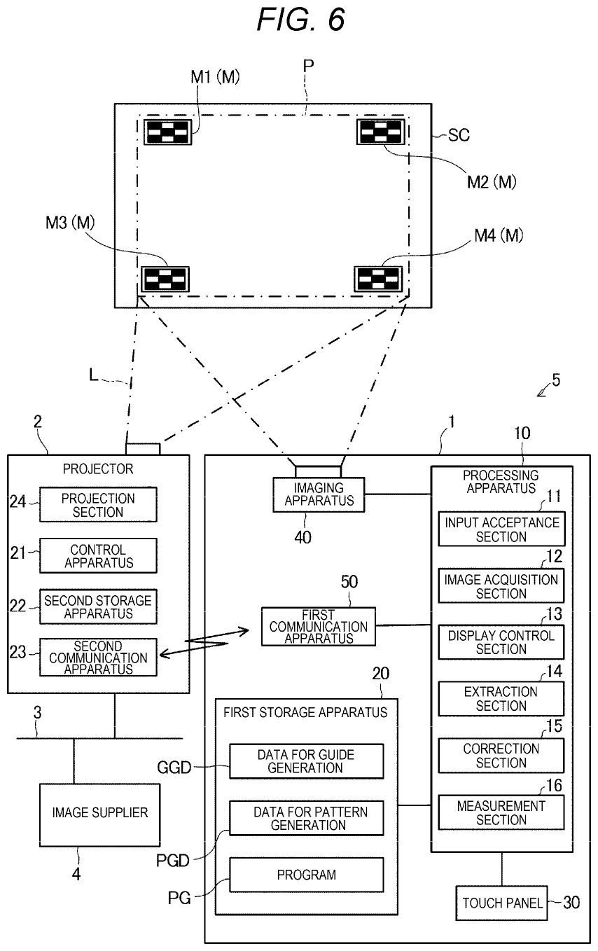

FIG. 6 shows an example of the configuration of the image display system 5 according to a second embodiment.

In the second embodiment, the detection apparatus 1 stores data GGD for guide generation and data PGD for pattern generation in the first storage apparatus 20. The other configurations are the same as those in the first embodiment.

In the following description, constituent portions common to those in the first embodiment have the same reference characters and will not be described.

In the first embodiment, the display control section 13 selects pattern image data PD stored in advance in the first storage apparatus 20 and transmits the selected pattern image data PD to the projector 2. The display control section 13 selects guide image data GD corresponding to the selected pattern image data PD from the guide image data GD stored in advance in the first storage apparatus 20 and displays the guide image G.

In the second embodiment, the display control section 13 uses the data PGD for pattern generation stored in the first storage apparatus 20 to generate the pattern image data PD and transmits the generated pattern image data PD to the projector 2. The display control section 13 generates the guide image data GD by using the data GGD for guide generation stored in the first storage apparatus 20 and causes the touch panel 30 to display the guide image G.

The data PGD for pattern generation is data for generating the pattern image data PD. For example, the data PGD for pattern generation contains image data on the markers M and data specifying the number of markers M contained in the projection image P and the positions of the markers M. The data PGD for pattern generation may include a parameter and a computation formula for generating images of the markers M.

The data GGD for guide generation is data for displaying the guide image G and contains, for example, data representing at least one of the number of markers M and the positional relationship among the markers M, and data representing the shape of the guide image G.

The detection apparatus 1 according to the second embodiment may or may not store the pattern image data PD or the guide image data GD in advance in the first storage apparatus 20.

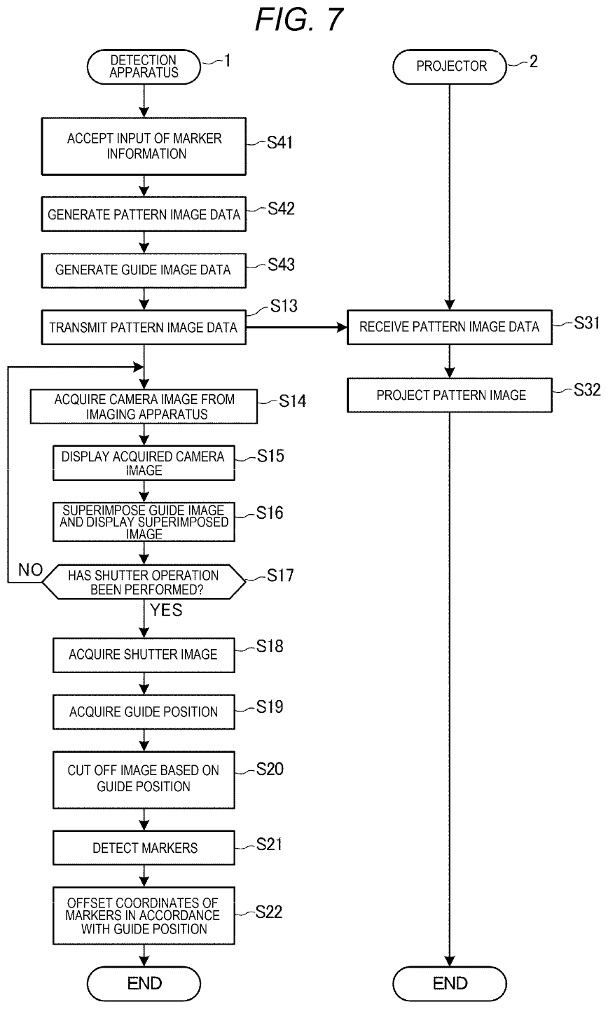

FIG. 7 is a sequence diagram showing the action of the image display system 5 in the second embodiment. Out of the actions shown in FIG. 7, actions common to those described with reference to FIG. 5 in the first embodiment have the same step numbers and will not be described.

The processing apparatus 10 of the detection apparatus 1 accepts input of marker information (step S41). The marker information is information that specifies at least one of the number of markers M to be located on the projection receiving object SC and the positional relationship among the plurality of markers M. The marker information is inputted, for example, by the user through touch operation performed on the touch panel 30.

The display control section 13 generates pattern image data PD that conforms to the marker information accepted as input in step S42 by using the data PGD for pattern generation (step S42). The display control section 13 generates the guide image data GD that conforms to the marker information accepted as input in step S42 by using the data GGD for guide generation (step S43). The guide image data GD generated in step S43 is temporarily stored in the first storage apparatus 20 and is used in the same manner as the manner in which the guide image data GD is used in the first embodiment.

The actions after step S43 are the same as those in the first embodiment.

As described above, the display method according to the second embodiment includes causing the detection apparatus 1 to generate the guide image data GD for displaying the guide image G, causing the detection apparatus 1 to generate the pattern image data PD for displaying the projection image P, transmitting the pattern image data PD from the detection apparatus 1 to the projector 2. In the display method according to the present disclosure, the projector 2 displays the projection image P based on the pattern image data PD transmitted from the detection apparatus 1. The detection apparatus 1 displays the guide image G based on the guide image data GD generated by the detection apparatus 1.

A variety of projection images P can thus be displayed on the projection receiving object SC without having to store many pattern image data PD in advance in the first storage apparatus 20. Therefore, since there are fewer restrictions on the number of markers M and the positional relationship among the markers M that the image display system 5 can use, the projection receiving object SC can be measured with higher accuracy.

The detection apparatus 1 accepts input of the marker information and generates the pattern image data PD and guide image data GD corresponding to the inputted marker information. Therefore, markers M suitable for the projection receiving object SC, which is a measurement target, can be located on the projection receiving object SC, and an image of the markers M can be captured. The projection receiving object SC can therefore be measured with higher accuracy.

In the second embodiment, when the content to be inputted as the marker information is prespecified, step S41 may be omitted. For example, when either or both of the number of markers M and the positional relationship among the markers M are determined in advance, step S41 is omitted. In this case, in steps S42 and S43, the pattern image data PD and the guide image data GD are generated in correspondence with at least one of the predetermined number of markers M and the predetermined positional relationship among the markers M.

### 3. Third Embodiment

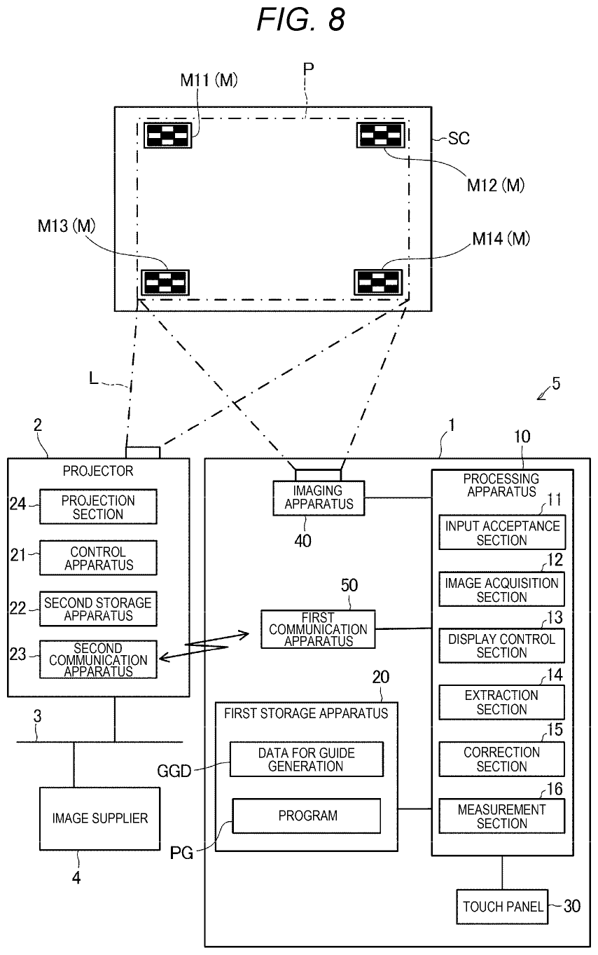

FIG. 8 shows an example of the configuration of the image display system 5 according to a third embodiment.

As described above, in the third embodiment, the markers M located on the projection receiving object SC are each an object stuck or otherwise placed onto the surface of the projection receiving object SC or drawn on the surface of the projection receiving object SC. Such markers M are referred to as physical markers below. FIG. 8 shows a case where four markers M11, M12, M13, and M14, which are physical markers, are located on the projection receiving object SC. Also when the markers M are physical markers, the number of markers M located on the projection receiving object SC may be two or more, as in the first and second embodiments.

The physical markers may each be a distinctive object that appears in an image captured by the imaging apparatus 40, such as a pattern or a protrusion on the projection receiving object SC. The physical markers may have an arbitrary shape, such as a circular, quadrangular, or triangular shape, and the positions where the markers are located may be arbitrary positions relative to the projection receiving object SC. The physical markers may be fixed in an arbitrary manner, for example, with an adhesive tape, a hook-and-loop fastener, or a magnet.

In the third embodiment, the detection apparatus 1 stores the data GGD for guide generation in the first storage apparatus 20. The other configurations are the same as those in the first and second embodiments. In the following description, constituent portions common to those in the first embodiment have the same reference characters and will not be described.

In the third embodiment, the display control section 13 generates the guide image data GD corresponding to the markers M, which are physical markers placed on the projection receiving object SC, and causes the touch panel 30 to display the guide image G. The process of generating the guide image data GD uses the data GGD for guide generation stored in the first storage apparatus 20. The data GGD for guide generation is the same as that in the second embodiment.

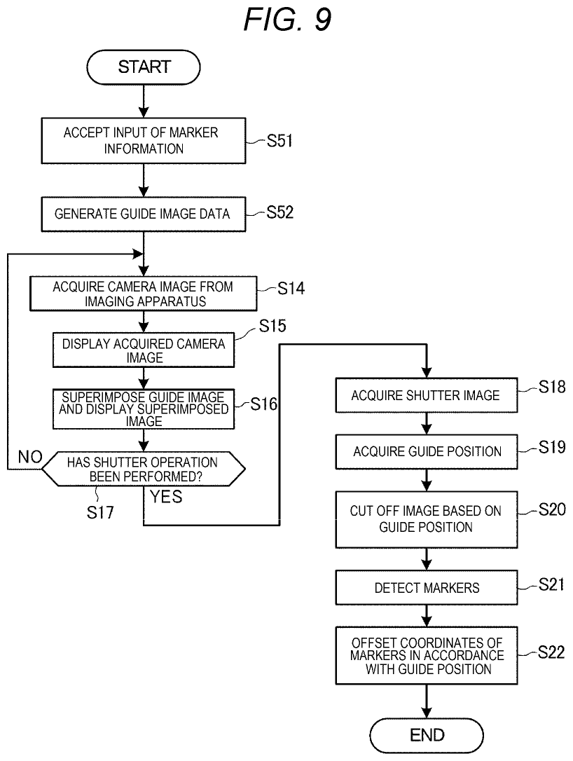

FIG. 9 is a flowchart showing the action of the image display system 5 in the third embodiment. Out of the actions shown in FIG. 9, actions common to those described with reference to FIGS. 5 and 7 have the same step numbers and will not be described.

The processing apparatus 10 of the detection apparatus 1 accepts input of the marker information (step S51). The marker information is information on the physical markers placed on the projection receiving object SC, that is, the markers M. Specifically, the marker information is information that specifies at least one of the number of markers M and the positional relationship among the plurality of markers M. The marker information is inputted, for example, by the user through touch operation performed on the touch panel 30.

The display control section 13 uses the data GGD for guide generation to generate the guide image data GD that conforms to the marker information accepted as an input in step S42 (step S52). The guide image data GD generated in step S52 is temporarily stored in the first storage apparatus 20 and is used in the same manner as the manner in which the guide image data GD is used in the first embodiment.

When the content to be inputted as the marker information on the physical markers located on the projection receiving object SC is prespecified, step S51 may be omitted. For example, when the number of markers M and the positional relationship among the markers Mare determined in advance and the detection apparatus 1 operates on the assumption that the markers M are located as determined, step S51 is omitted.

In the display method according to the third embodiment, the markers M are physical markers placed or formed on a real object present at the projection receiving object SC. The detection apparatus 1 displays on the touch panel 30 the guide image G, which includes a guide corresponding to the number of markers M located on the projection receiving object SC or the positional relationship among the plurality of markers M, with the guide image G superimposed on the first image.

Therefore, when the physical markers are used to measure the projection receiving object SC, the guide image G assists the user in capturing an image of the markers M by using the detection apparatus 1. Therefore, when using the physical markers, the user can readily capture a shutter image suitable for the measurement.

The display method described above includes causing the detection apparatus 1 to receive input of information on the number of physical markers to be located on the projection receiving object SC or the positional relationship among the plurality of physical markers, and generating the guide image data GD for displaying the guide image G based on the inputted information. The detection apparatus 1 displays the guide image G based on the generated guide image data GD. The detection apparatus 1 can thus display the guide image G corresponding to the number of physical markers placed on the projection receiving object SC and the positional relationship among the physical markers. The restrictions on the placement of the physical marker can therefore be relaxed, whereby the projection receiving object SC can be more readily measured.

### 4. Fourth Embodiment

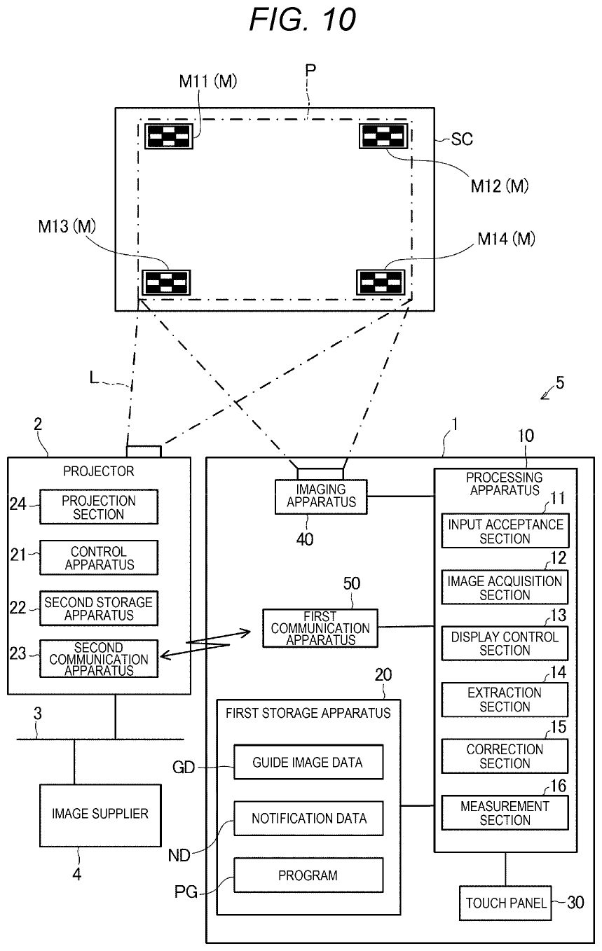

FIG. 10 shows an example of the configuration of the image display system 5 according to a fourth embodiment.

In the fourth embodiment, the markers M located on the projection receiving object SC are physical markers.

In the fourth embodiment, the detection apparatus 1 stores the guide image data GD and notification data ND in the first storage apparatus 20. The other configurations are the same as those in the first, second, and third embodiments. In the following description, constituent portions common to those in the first embodiment have the same reference characters and will not be described.

In the fourth embodiment, the display control section 13 displays the guide image G on the touch panel 30 in accordance with the guide image data GD stored in the first storage apparatus 20.

The detection apparatus 1 prompts the user to locate the markers M the number of which corresponds to the guide image G on the projection receiving object SC based on the positional relationship corresponding to the guide image G. To this end, the detection apparatus 1 sends notification to the user in accordance with the notification data ND. The notification to the user is achieved, for example, by the display control section 13 through display of an image or a text on the touch panel 30. The process of prompting the user to locate the markers M the number of which corresponds to the guide image G on the projection receiving object SC based on the positional relationship corresponding to the guide image G corresponds to an example of the process of causing the number of physical markers or the positional relationship among the plurality of physical markers to correspond to the guide image data. That is, the process is not limited to a specific process and may be any process of causing the user to be informed of the number of physical markers M to be located on the projection receiving object SC or the positional relationship among the plurality of physical markers. The process may be the process of notifying the user of the number of markers M or the positional relationship among the markers M, may include the process of prompting the user to locate the markers M as notified, or the process of ascertaining that the markers M have been located as notified.

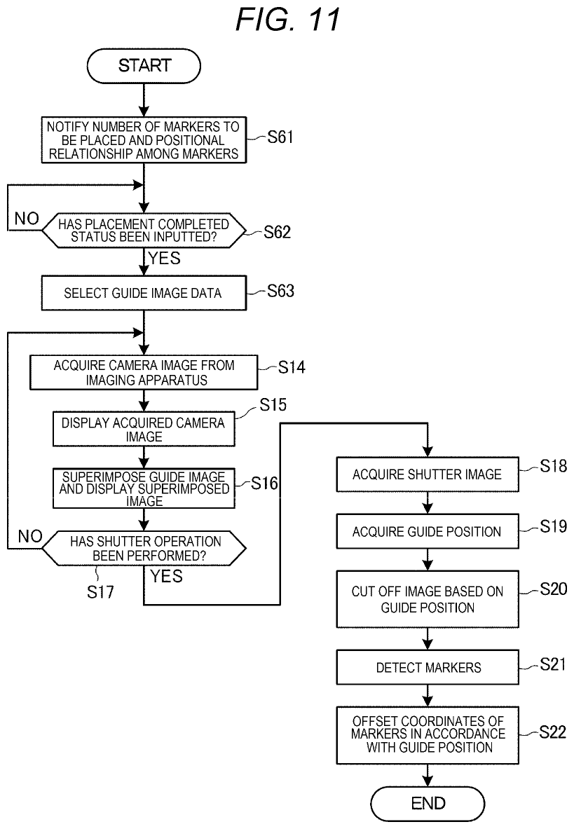

FIG. 11 is a flowchart showing the action of the image display system 5 in the fourth embodiment. Out of the actions shown in FIG. 11, actions common to those described with reference to FIGS. 5, 7, and 9 have the same step numbers and will not be described.

The processing apparatus 10 sends the notification in accordance with the notification data ND by using the function of the display control section 13 (step S61). The content of the notification is a content that informs the user of the number of markers M that should be placed on the projection receiving object SC and the positional relationship among the markers M.

The processing apparatus 10 waits until there is input representing that the placement has been completed (step S62), and when the input of the placement is completed (YES in step S62), the processing apparatus 10 transitions to step S63. In step S63, the processing apparatus 10 selects the guide image data GD stored in the first storage apparatus 20 and performs the actions in step S14 and the following steps.

When the number of physical markers M to be located on the projection receiving object SC and the positional relationship among the markers M are determined in advance and the detection apparatus 1 operates on the assumption that the markers M are located as determined, steps S61 and S62 are omitted.

In the display method according to the fourth embodiment, the markers M are physical markers placed or formed on a real object present at the projection receiving object SC. The detection apparatus 1 displays the guide image G based on the guide image data GD, which the detection apparatus 1 stores in advance. The detection apparatus 1 carries out the process of causing the number of physical markers to be located on the projection receiving object SC or the positional relationship among the plurality of physical markers to correspond to the guide image data GD.

The projection receiving object SC can thus be measured by using the physical markers.

The detection apparatus 1 sends notification that achieves the state in which the number of physical markers or the positional relationship among the plurality of physical markers corresponds to the guide image data GD. The user can therefore place the physical markers in a proper state. The user can place the marker M in proper positions in accordance with the notification from the detection apparatus 1. The burden on the user who uses physical markers can therefore be reduced.

The notification in step S61 is not limited to notification displayed on the touch panel 30. When the detection apparatus 1 has a voice output function, the notification may be sent in the form of voice. Still instead, the detection apparatus 1 may transmit image data or voice data based on the notification data ND to the projector 2, and the projector 2 may send the notification.

### 5. Other Embodiments

The embodiments described above show specific examples to which the present disclosure is applied, and the present disclosure is not limited thereto.

In the image display system 5, the markers M contained in the projection image P from the projector 2 may be used along with the markers M that are physical markers.

In the embodiments described above, the projector 2 is presented as an example of the display apparatus. The display apparatus is not limited to the projector 2 and may instead be a liquid crystal display that displays images on a liquid crystal display panel. The display apparatus may still instead be a display apparatus that displays images on a plasma display panel or an organic EL (electro luminescence) panel. In this case, the liquid crystal display panel, the plasma display panel, or the organic EL panel corresponds to an example of the display section.

The functional portions shown in the block diagram of the image display system 5 each represent a functional configuration and are each not necessarily implemented in a specific form. For example, in the detection apparatus 1, hardware corresponding to each of the functional portions is not necessarily implemented, and a single processor that executes a program can, of course, achieve the functions of the plurality of functional portions. Further, part of the functions achieved by software in the embodiments described above may be achieved by hardware, or part of the functions achieved by hardware in the embodiments described above may be achieved by software. In addition, the specific detailed configuration of each of the other portions of the image display apparatus 5 can be arbitrarily changed to the extent that the change does not depart from the substance of the present disclosure.

What is claimed is:

1. A display method comprising:
acquiring a first image by causing a camera to capture an image of a target area in which markers are located;
displaying the first image on a display panel of a detection apparatus; and
displaying a second image superimposed on the first image on the display panel, the second image including a guide corresponding to number of the makers located in the target area or a positional relationship among the markers.

2. The display method according to claim 1, further comprising displaying, by a display apparatus, a third image containing the markers in the target area.

3. The display method according to claim 2,
further comprising transmitting pattern image data that the detection apparatus stores in advance from the detection apparatus to the display apparatus,
wherein the display apparatus displays the third image based on the pattern image data transmitted from the detection apparatus, and
the detection apparatus displays the second image based on guide image data that the detection apparatus stores in advance.

4. The display method according to claim 2, further comprising:
generating, by the detection apparatus, guide image data for displaying the second image;
generating, by the detection apparatus, pattern image data for displaying the third image; and
transmitting the pattern image data from the detection apparatus to the display apparatus,
wherein the display apparatus displays the third image based on the pattern image data transmitted from the detection apparatus, and
the detection apparatus displays the second image based on the guide image data generated by the detection apparatus.

5. The display method according to claim 1,
wherein the markers are physical markers placed or formed on a real object present at the target area, and
the detection apparatus displays on the display panel the second image, which includes a guide corresponding to number of the physical markers located in the target area or a positional relationship among the physical markers.

6. The display method according to claim 5, further comprising:
receiving, by the detection apparatus, input of information on the number of the physical markers to be located in the target area or the positional relationship among the physical markers; and
generating guide image data for displaying the second image based on the information,
wherein the detection apparatus displays the second image based on the guide image data.

7. The display method according to claim 5,
wherein the detection apparatus displays the second image based on guide image data that the detection apparatus stores in advance, and
the detection apparatus carries out the process of causing number of the physical markers to be located in the target area or the positional relationship among the physical markers to correspond to the guide image data.

8. The display method according to claim 1, wherein the detection apparatus executes one of a first mode in which the second image in a first visual aspect is displayed and a second mode in which the second image in a second visual aspect different from the first visual aspect is displayed.

9. The display method according to claim 1,
wherein the markers located in the target area include a first marker and a second marker,
the first image contains a plurality of image areas,
the plurality of image areas include a first image area and a second image area,
the second image is an image showing a boundary between the plurality of image areas, and
the first image area is associated with the first marker located in the target area, and the second image area is associated with the second marker located in the target area.

10. The display method according to claim 9, wherein the image showing a boundary is line segments that divide the first image into the plurality of image areas.

11. The display method according to claim 9, further comprising detecting, by the detection apparatus, a position of the first marker based on values of pixels contained in the first image area out of pixels that form the first image and detect a position of the second marker based on values of pixels contained in the second image area out of the pixels that form the first image.

12. A detection apparatus comprising:
a display panel;
a camera;
at least one processor that executes:
acquiring a first image by causing the camera to capture an image of a target area in which markers are located;
displaying the first image on the display panel; and
displaying a second image superimposed on the first image on the display panel, the second image including a guide corresponding to number of the makers located in the target area or a positional relationship among the markers.

13. A non-transitory computer-readable storage medium storing a program for making a computer execute a method comprising;
acquiring a first image by causing a camera to capture an image of a target area in which markers are located; and
displaying the first image on a display panel; and
displaying a second image superimposed on the first image on the display panel, the second image including a guide corresponding to number of the makers located in the target area or a positional relationship among the markers.
